(19) United States
(12) Patent Application Publication
(10) Pub. No.: US 2023/0066992 A1
(43) Pub. Date: Mar. 2, 2023

(54) SYSTEMS AND METHODS FOR IDENTIFYING AND VERIFYING ASSETS AND EMPLOYMENT INFORMATION AT A CONSTRUCTIONS SITE

(71) Applicant: The Headcount Inc., St. Louis, MO (US)

(72) Inventors: Ajay Dham, St. Louis, MO (US); Elmer Rhodes, St. Louis, MO (US)

(21) Appl. No.: 17/897,877

(22) Filed: Aug. 29, 2022

Related U.S. Application Data
(60) Provisional application No. 63/239,168, filed on Aug. 31, 2021.

(51) Int. Cl. G06Q 10/06; G06Q 10/10

(52) U.S. Cl. CPC G06Q 10/063114; G06Q 10/0635; G06Q 10/1091

(57) ABSTRACT

A method and system to automate and input the collection of payroll related information in real-time by contractors that perform work for government and private actors. This method and system includes the automation of identifying contractors' workforce on and -off the job-site in real-time, the automation of collection of data from the job-site to provide government and private actors with certified payroll related information, validating wage determination on submittal by a database repository of pre-defined wage schedules, identification in real-time of any wage theft, and notification in real-time of any on-site job-site workforce not meeting singular or plurality safety requirements. This method and system also includes identifying, in real-time, contractors' current workforce statistical information allowing government and private actors to monitor in real-time their workforce objectives. Additionally, this method and system allows for the individual laborer to validate in real-time their work hours otherwise that were not reported.

### CROSS-REFERENCE TO RELATED APPLICATIONS

This application claims the benefit of U.S. Provisional Application No. 63/239,168, filed Aug. 31, 2021, the entirety of which is hereby incorporated by reference herein.

### STATEMENT REGARDING FEDERALLY SPONSORED RESEARCH

Not Applicable.

### BACKGROUND

The present invention relates to automatic collection and determination in real-time of certified payroll information, prevailing and non-prevailing wage and fringe benefits determination, autonomous worker time-card entries, and cross-over prevailing wage and labor union worker wage and fringe benefit determinations. Worker and employer manual input, which is subject to error and fraud, is replaced by automated communication using a worker-worn device, gateway, management server, and contractor device. Furthermore, the systems and methods of the present invention provides the ability to track government and private agency contractor job-sites in real-time indoor, outdoor, horizontally, and vertically. Additionally, the systems and methods of the present invention provides contractors with real-time statistical information regarding individual workers, cohorts of workers, demographics of the workforce and total workforce at a job-site for enhanced project insight and to report in real-time to their government and/or private agencies. Such statistical information can include estimated burn-rate (e.g., spending on worker wages) prior to any certified payroll submission, real-time project statistics (e.g., workforce diversity breakdown by gender, ethnicity, demographics, locality, etc.), and any singular or plurality of workforce objectives. The system and method of the present invention also identifies, in real-time, in any emergency situation the identity of missing, injured and/or ill workers (e.g., using data from a worker-worn device such as radio frequency identification, Bluetooth low energy, etc.).

By providing these functions using the systems and methods of the invention, several problems are overcome and several benefits are provided. There exist mandates/requirements for any contractor who opts to perform services for any government entity (e.g., federal, state, city, county, etc.) related projects. As an example, within the construction sector, contractors are required to report their workforce usage by completing and submitting the U.S. Department of Labor Wage Hour Form 347 at a given period (e.g., weekly, monthly, etc.). The parameters for the Wage Hour Form to be collected are, but not limited to: worker name, worker identification number (i.e., SSN), worker classification, worker labor type, worker hours worked by day and broken down by straight-time, over-time and double-time, worker hourly base rate, worker fringe benefits, worker gross amount earned, worker deductions and worker net wages. Depending on the industry and jurisdiction, additional parameters can be collected or needed. The end-result of the input parameters is the Wage Hour Form 347 or like, depending on the industry.

The complication in satisfying mandatory reporting requirements is not the generation of the Wage Hour Form 347 or like forms, but the truthfulness of the collection of data and reported data. For example, manually input and collected data is subject to inaccuracies and fraud. As one example, a manager or supervisor manually tracking the time of workers spent on a job-site (e.g., using a paper timesheet) is subject to error (e.g., not noticing when a worker arrives) and fraud (e.g., intentional undercounting of time, backdating, etc. to reduce wage payments improperly). Automatic and real-time tracking of the type removes human error/fraud provides for more accurate reporting and allows for better compliance. Furthermore, the classification of the job type determines which pay schedule to utilize to determine the wages of the worker: prevailing wages, Davis-bacon wages, union wages or private wages. It is difficult for a contactor operating at differently-classed jobs to track its workforce and apply different pay schedules. This can result in error through the manual application of pay schedules to jobs and workers (e.g., an employee at a contractor inadvertently applies an improper pay schedule to a job/workers at that job). The systems and methods of the present invention overcome this problem and provide more accurate wages and reporting by collecting and applying data automatically.

It is typically the requirement of a single individual, such as a compliance specialist, to review and validate that every contractor (e.g., sub-contractor) is fulfilling their responsibility by not short-paying any of the workforce on the job. These compliance specialists are responsible for reviewing the Wage Hour Form or like forms/data for each contractor (e.g., sub-contractor) on the job and determining the truthfulness of the data reported. Relying on manual review and manually provided data from contractors (e.g., sub-contractors) who are in-turn collecting data manually (e.g., relying on a supervisor's paper timesheet) can introduce unacceptable error and fraud. The systems and methods of the present invention remove manual data collection and reporting and therefore provide more accurate and less fraud prone data to the compliance specialist of a general contractor. This makes reporting, tracking, auditing, etc. of data from multiple contractors (e.g., sub-contractors) more accurate and easier through real-time data collection and analysis through specialized hardware.

Wages for workers are defined by an array of agencies, such as, but not limited to: unions, government agencies (federal, state, city and county), private agencies (i.e. general contractors.) The present system allows for these agencies to upload the wages and fringe benefits which then reduces the likelihood of a worker being short paid.

### BRIEF SUMMARY

Briefly, the present invention enables agencies/actors/general contractors/etc. to allow for real-time data collection of a worker's activity enabling contractors to have more accurate information. The more accurate information combats wage-theft and provides greater authenticity of a worker at the job-site. With the collection of the workers real-time data, the method and system described herein is autonomously able to determine the period duration and wage type of a singular or plurality of workers at a jobsite without any outside interference (e.g., input or reliance on manual data entry or reporting).

Government (federal/state/city/county/other government municipalities . . . ) and non-government related projects may by definition establish a worker's wage by project type (prevailing wages, davis-bacon wages, union wages and/or private wages), project location, worker classification, worker labor category and number of hours worked which then are required to be validated by specialists. The systems and methods disclosed herein provide for automatic determination of workers' validated wage rates based on this set of parameters without any intervention (e.g., manual data entry).

Additionally, the systems and methods disclosed herein provide for contractors to be able to be alerted of any worker deficiencies in real-time (e.g., missing workers, unaccounted for time, workers in unauthorized or unexpected locations, accidents, etc.). As another example, a deficiency of a worker can be a certification that worker must have in order to perform their job function/duties but that the worker is lacking. The system is able to determine in real-time if any of the certifications, per this example, are invalid thereby reducing any risks this worker or the employer may be responsible for fines or other regulatory penalty.

Furthermore, it is increasing common that a job-site worker is not the authentic laborer who was hired to perform the task at the job-site. Through the system and method's mobile function described herein, a contractor or other employer can determine in real-time the authenticity of a worker and in real-time have access to their documents, such as, but not limited to, licenses, certifications, agreements, contracts, health information and/or the like.

Traditionally, labor workers carry a notebook in by which they document their daily hours which are then reported to their upper management at the job-site and then transferred for payroll at the sub-contractors office. During this transition and manual input of daily hours, hours are commonly miss-reported or the type of work being performed by the worker is miss-classified. Providing the ability to the labor worker to view their submitted payroll to cross-reference the payroll data ensures that they are not being cheated out of their hours and wages and fringe benefits. In the event an anomaly is detected by the laborer/worker, it can be immediately reported from within a mobile application raising flags.

With the present invention the systems and methods described are able to provide, in real-time, the current workers (e.g., their identifications) on the job-site and further the number of workers per labor category, classification, union relationship, project objectives, goals and/or the like. It is to be noted that other parameters can be displayed in real-time as needed.

Other existing project and workforce management systems and methods do not provide for the benefits of the currently disclosed systems and methods and existing systems and methods suffer from the problems previously described. Existing systems and methods do not allow for the input of real-time data in any means. Existing systems do not provide for automation of the input of data. They further do not allow for the real-time verification of a worker thorough a mobile app (e.g., running on a worker's smartphone or a dedicated worker-worn device). The advantage by having this automated data as opposed to manual input systems is that it does not allow for workers to be cheated out of their earned value, otherwise referred to as ‘wage theft.’

Additionally, being able to identify in real-time an instance where medical services are needed and knowing by a click of a finger what drug allergies or other medical issues the worker has can be key to a life or death situation. These medical records can be stored in a management server and queried using a handheld contractor device which identifies a worker by interfacing with the worker's device (e.g., a smartphone or dedicated worker-worn device).

In summary, the system and methods are designed to collect, analyze, and alert in real-time. The systems and methods providing these and other functions and advantages are further detailed in the following description.

### DESCRIPTION OF THE DRAWINGS

In the accompanying drawings which form part of the specification:

FIG. 1 is network diagram for autonomous data collection related to job-site workers;

FIG. 2 is a network diagram of a system and its functions for processing and otherwise using the data collected as depicted in FIG. 1;

FIG. 3 is a flowchart illustrating a method, executed by the system described herein, to define wages for workers at one or more job-sites;

FIG. 4 is a network diagram of the system for validating worker identities;

FIG. 5 is a schematic diagram illustrating a worker-contractor relationship as facilitated and improved by the systems and methods described herein;

FIG. 6 is a schematic diagram illustrating the relationship between worker-worn or carried devices, one or more gateway 102s, a management server, a handheld contractor device, and a contractor device for carrying out the functions described herein; and

FIG. 7 is a schematic diagram illustrating the use of a security device in verifying worker identity, worker duration and presence on a job site.

### DETAILED DESCRIPTION

The following detailed description illustrates the disclosed systems and methods by way of example and not by way of limitation. The description enables one skilled in the art to make and use the disclosed system and methods, describes several embodiments, adaptations, variations, alternatives, and uses of the asset and employee information management systems and methods, including what is presently believed to be the best mode of making and using the systems and methods. Additionally, it is to be understood that the asset and employee information management systems and methods are not limited to the details of construction and the arrangements of components set forth in the following description or illustrated in the drawings. The disclosed asset and employee information management systems and methods are capable of other embodiments and of being practiced or being carried out in various ways. Also, it is to be understood that the phraseology and terminology used herein is for the purpose of description and should not be regarded as limiting.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts are causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

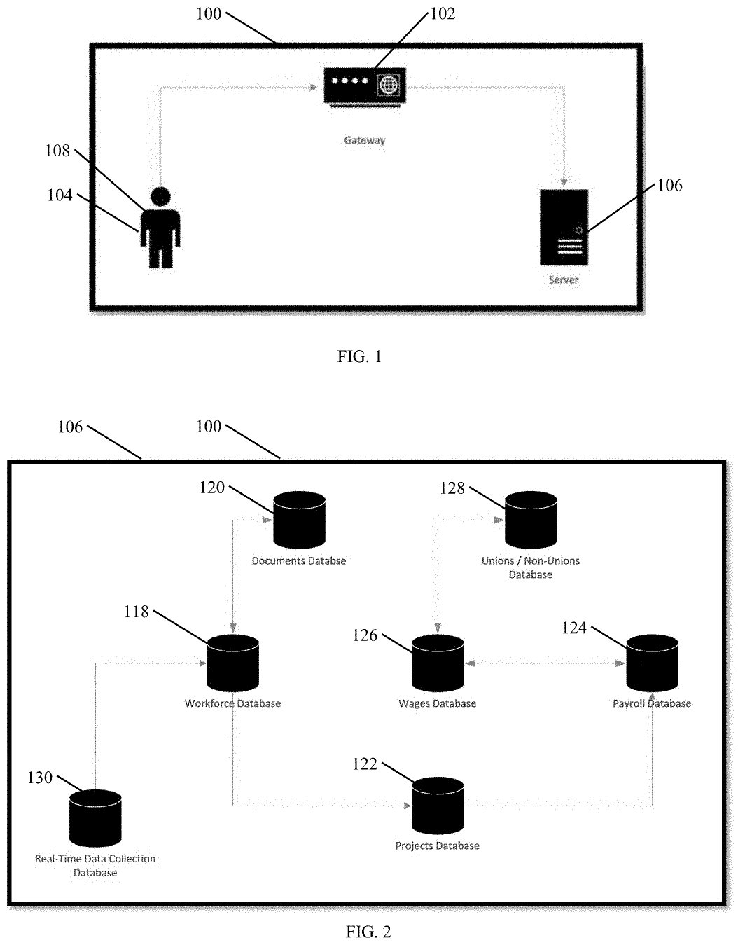

Referring generally to FIGS. 1-6, embodiments of the system 100 and method that allows for the collection and determination of payroll related information autonomously in real-time from a job-site and real-time identification of the on-the-job-site workforce is described in detail as follows.

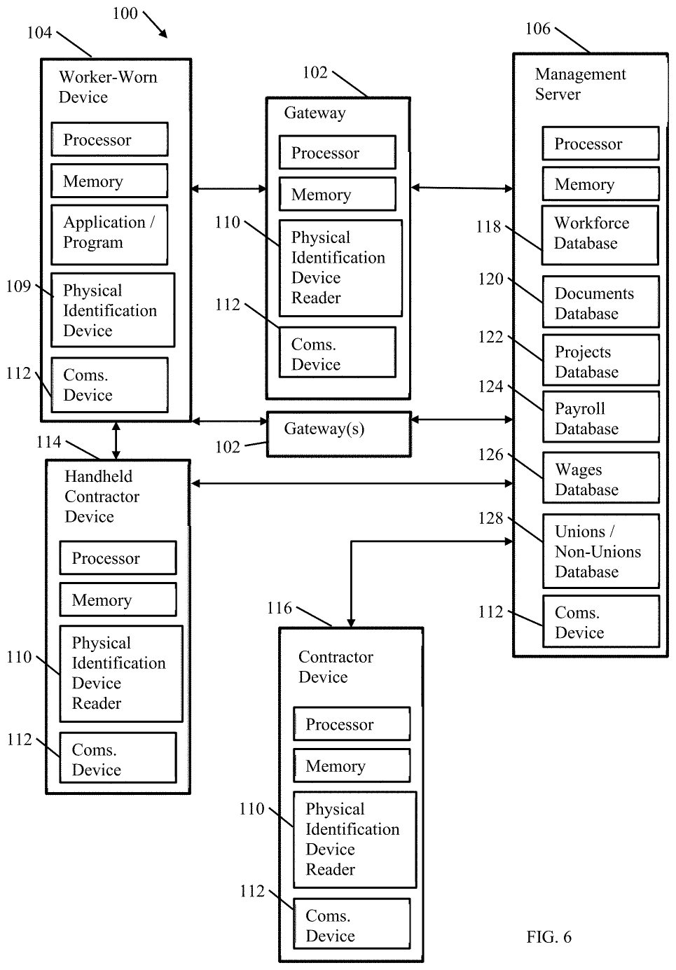

Referring to FIGS. 1 and 6, to allow for the real-time data collection at the job-site, the system 100 includes a gateway 102 that allows for data to be collected from worker worn devices 104 and transmitted, by the gateway 102, to a centralized server 106. The gateway 102, as shown in FIG. 6 in more detail, includes components for collecting data from worker-worn or carried devices 104 (also as shown in more detail in FIG. 6). The gateway 102 transmits signals from the devices 104 worn by the worker 108 and received from the devices 104 worn by the worker to a centralized server 106 (e.g., management server shown in more detail in FIG. 6) as seen in FIG. 1. The worker-worn device 104 is worn by the user 108 and can include a physical identification device 109 such as, for example, a Radio Frequency Identification (RFID) (active/passive) component, Quick Response (QR) Code, Barcode, Bluetooth module, GPS module, LoRa module, NFC module, finger-printer reader, and/or other equipment or components for the communication of information. Associated identification information stored on the device 104 and information captured by the device 104 (e.g., location information, heartbeat monitor data, etc.) can be transmitted to the gateway 102. For example, the device 104 can be issued to a specific worker and an identification associated with the device is linked in a database (e.g., managed by the server 106) to the worker 108 to whom the device 104 is assigned. Location information can be GPS information (e.g., received from a GPS receiver of the communications device 112) or can be a location signal that is recorded by one or more gateways 102 and can be used to determine location by triangulation between multiple gateways 102 or by proximity to a particular gateway 102. The worker device 104 includes an application/program operating thereon to facilitate the functions described herein. The gateway 102 transmits the signals received by the device 104 worn by the worker to the centralized server 106 (e.g., a management server) where it gets further processed and matched to a worker 108 in the central workforce repository (e.g., using an ID transmitted from the worker-worn device 104 to the gateway 102). When the management server 106 receives the transmitted signal, it contains at minimum the following parameters: unique identification number (being forwarded from the worker-worn device), timestamp, and a Gateway ID from where the signal was received from (e.g., a unique identification allowing for the identification of the receiving gateway 102 and its corresponding location). This Gateway ID in some instances, for example, can be the MAC Address of the Gateway 102, although there may be other identification methods of the Gateway 102. While the worker-worn device 104 can be a purpose-built device, in some embodiments, the worker-worn device 104 is a smartphone carried by the worker and running an application thereon which makes use of the smartphone hardware to communicate with the gateway 102 in the manner described herein. In some embodiments, the worker-worn device 104 is not a smartphone or other worker provided device in order for the system to maintain control over the devices. The operator of the system provisions purpose bulti, non-smartphone, worker devices 104. The use of purpose built devices limits the functions available to the worker and can reduce error that can be introduced by a device outside the primary control of the system and its operator.

The Gateway 102 allows for the transmittal of data in real-time. The gateway 102 houses a reading device 110 (e.g., physical identification device reader), power source, communications device 112 (e.g., a modem, cellular modem, signal transceiver, WiFi transceiver, or the like) and antennas (e.g., internal or external and stand alone or integral to the communications device 112) for the communications device 112 and/or reading device 110. Depending on the device 104 worn by the worker, the reading device 110 is interchangeable and/or include multiple types of reading devices. For example, the reading device 110 may be a barcode scanner, QR scanner, NFC interrogator, WiFi interrogator, Bluetooth interrogator, or the like. The reader 110 interrogates nearby worker-worn devices automatically and periodically using communication and/or scanning of the worker-worn device 104 to receive the data described herein. For a successful transmission of data to happen in real-time, the signaling device 104 worn by the worker and the gateway 102 must be present and operational. The Gateway 102 transmits the data to the centralized server 106 each time the signaling device 104 comes within range of the gateway 102. In embodiments where the worker-worn device 104 is a smartphone, the gateway may be one and the same as the management server 106 with the smartphone automatically and periodically communicating the location of the device to the server 106.

In some embodiments, the system 100 further includes a handheld contractor device 114. The handheld contractor device 114 functions as a mobile gateway. The handheld contractor device 114 includes a physical identification device reader 110 and communications device 112. The handheld contractor device 114 can replace (e.g., the handheld contractor device 114 communicates directly with the server 106) or supplement the gateway(s) 102. The handheld contractor device allows for spot checks of individual workers by querying their device 104. In some embodiments, the handheld contractor device 114 includes a GPS system or other source of location/position data (e.g., triangulation using other gateways) that can be used to report the location of worker devices interrogated by the handheld contractor device 114. In some embodiments, the handheld contractor device 114 includes user interface elements that allow a user to interact with the server 106 to query and display information related to one or more workers (e.g., a worker corresponding to a scanned device 104 and/or all workers).

The system 100 further includes a contractor device 116. The contractor device 116 can be a general or special purpose computer (e.g., desktop computer, laptop, smartphone, tablet, etc.) for querying information form the server 106, inputting information into a database of the server 106, or otherwise interacting with other components of the system 100. In some embodiments, the contractor device 116 can be a stationary device also with a device reader 110. The contractor device 116 includes a communications device 112 to facilitate communication with other components of the system 100.

The system 100 includes the server 106. The server includes a communications device 112 for communicating with other components of the system 100. The server 106 includes a variety of databases for storing information used in the system 100. The databases can include a workforce database 118, documents database 120, projects database 122, payroll database 124, wages database 126, unions/non-unions database 128, and/or other databases. It should be understood that in some embodiments, a single database can be used for all such databases. A variety of database structures can be used in different embodiments.

The worker-worn device 104, gateway 102, management server 106, handheld contractor device 114, and contractor device all include a processor and memory of the type described herein or other suitable type. The processor and memory combine to provide for the functions described herein including controlling hardware, storing and running programs, storing data, and the like.

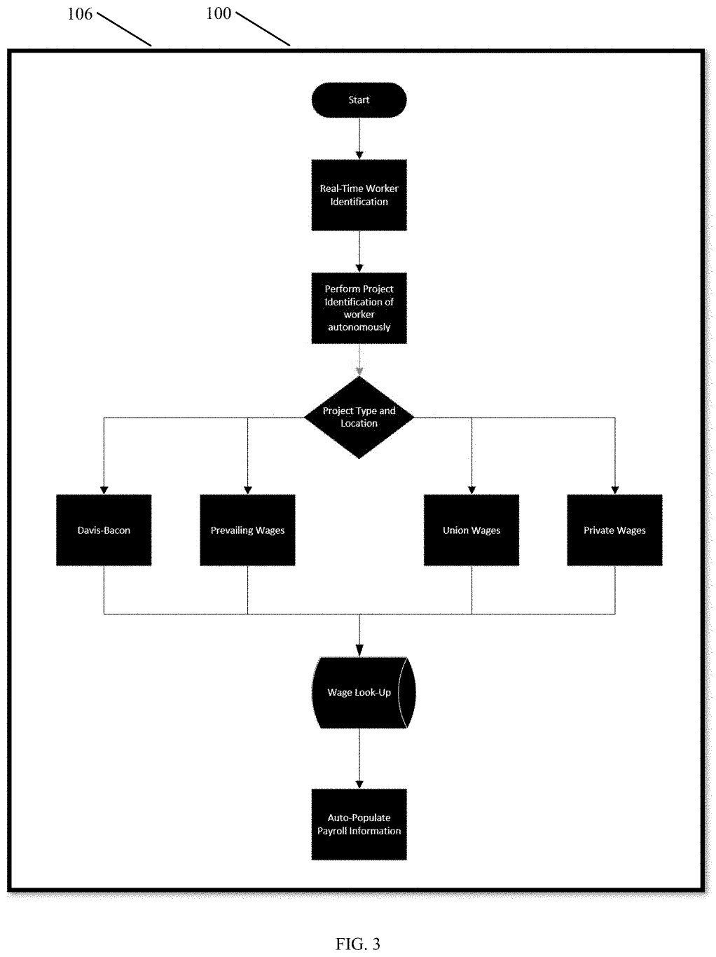

Referring now to FIG. 2, the management server 106 receives information from one or more gateways 102 and/or handheld contractor devices 114 corresponding to a worker-worn device 104 and including related information (e.g., a worker device identifier, location data, heartbeat, and/or other information) and utilizes it using the illustrated database/network structure and data flows. The received information from the worker device 104 is stored in a real-time data collection database 130 and is correlated with a worker (e.g., by reference to the workforce database 118). The server 106 also receives information to populate the other databases. For example, such information can be input through the contract device 116. Received data is placed into the real-time data collection database 130 in real-time and the server 106 uses this information to provide the functions described herein. The system and its methods are able to, in real-time, determine a worker's wage. As shown in FIG. 2, the ‘Real-Time Data Collection Database’ is a storage device that contains the events received from the Gateway 102 as demonstrated in FIG. 1. This event data is then sent through an application programming interface (API) which searches the workforce directory database 118 to determine if a match exists between identification device 104 worn by the worker and one assigned to a worker in the workforce database 118. The system 100 maintains (e.g., on server 106) a repository of assigned workers to a job-site (e.g., in the workforce database 118 or projects database 122). There does exists a one-to-many relationship in that a worker can be assigned to more than one project. With the combination of the gateway 102 dentification and job-site project database 122 (e.g., a listing of workers assigned to particular job-sites stored in the workforce database 118 or projects database 122), the system 100 (e.g., using the management server 106) is able to determine if the worker is assigned to a job-site. When more than one event data from the worker device 104 has been received at the server 106 from the gateway 102 (and/or handheld contractor device 114) from the same worker, the system updates the difference in time and denotes it as the duration the worker has performed its duties on the job-site. This data is typically updated multiple times in a day (e.g., gateways 102 periodically query all devices 104, gateways 102 automatically query nearby device 104 upon proximity and automatically upload to server 106, etc.). As shown in FIG. 2, the differential in time is noted on the timesheet of a worker in the payroll-related database 124. The timestamp of data received from the device 104 allows for server 106 to determine the appropriate and real time wages for individual workers.

Referring now to FIG. 3, the management server 106 determines the wages owed to a worker. Through either a manual process or automated, the project type can be defined as of type: Prevailing Wage, Davis-Bacon, Union and Private. Private is for all wages outside of the initial three mentioned. Per FIG. 2, after the identification of the project type, the system (e.g., server 106) goes through a repository of wages, where it will match the project type, the worker classification, and worker labor category at minimum and return the assigned hourly wages and fringe benefits. For explanation purposes, assume a single worker could be performing work for multiple projects. One project may be of type ‘Prevailing Wages’ whereas the other may be of type ‘Union.’ When the wages and fringe benefits are determined for this worker for both projects it may be that for each project he is earning a different wage and fringe benefit. In one project he may earn the wage and fringe benefit as defined by the prevailing wage rate schedule and on the other project he may earn the rate and fringe benefits defined by the union the member is signatory to. The management server 106 queries the relevant databases to make this determination and determines the total wage using this wage rate information and the amount of worked time determined using the worker-worn device 104 and the gateways 102 as described herein. Referring still to FIG. 3, the server 106, at start, receives real-time worker identification information from the gateway(s) 102 based on the presence of the worker device 104. The data is stored in the relevant database (e.g., real-time data collection database 130). In the next step, the server 106 performs project identification of the worker autonomously and automatically by correlating the worker (e.g., by device 104 identity and/or associated worker identity in the workforce database 118) with assigned projects by querying the projects database 122. The server 106 uses the project information stored in the projects database 122 to determine the project type and location in order to determine the appropriate wage to pay for the worker and/or using the type of worker (e.g., union or non-union worker as stored in the workforce database 118 and/or unions/non-unions database 128). The server 106 upon determining the type of wage to be paid and the project type to perform a wage look-up (e.g., querying a wages database 126 for the corresponding wage value). The server 106 then auto-populates payroll information for the worker (e.g., multiplying the wage value from the wage lookup based on the project information and wage type with the amount of time worked based on the real-time data collected from the worker device 104 using the gateways 102).

In many instances, a worker may be signatory to a union, but be performing a job outside the jurisdiction of which the union is signatory to. To better describe this, assume there is a union A who is signatory to counties X, Y and Z. If the member/laborer/worker of Union A is performing their services within counties X, Y and Z then the member/laborer/worker is to receive the wages and fringe benefits of Union A. If the member/laborer/worker is working outside the jurisdiction of Union A and working in Union Bs jurisdiction, then the system allows you to manually select a different wage and different fringe benefits due to cross jurisdiction. In some embodiments, this selection occurs automatically based on location information received from the gateway (s) and database entries defining the relevant jurisdictions. In cases like this the member/laborer/worker may get his wages as defined by Union B, but fringe benefits based on Union A. It must be noted that this was for explanation purposes only and there are other scenarios that can be played out which is managed by the system.

Contractors have the ability to review and validate the returned wage rate and fringe benefits and may alter the data as required. The contractor can also alter the automated duration calculated by the system or manually add the duration of the worker for the specific job-site, hence, the system and method allows for the collection and determination of payroll related information autonomously in real-time from the job-site.

In other words the system 100 including the variety of databases, it allows for different wages broken down by unions, prevailing wages, davis bacon wages, and private wages. For prevailing wages, they are broken down by county and furthermore a start and end date. For example, St. Louis County, Missouri has a prevailing wage rate accessible for example at https://laborwebapps.mo.gov/dls/prevailingwage. As shown here, to determine a prevailing wage a person must first select the county for which they want to see the wage schedule for. If for instance they select St. Louis County, it will show their current wages. The system 100 allows for the input of each of these prevailing wages in our database. The server 106 can similarly store wage information for other jurisdictions. When the user of the system 100 selects prevailing wage and the correct labor category, the server 106 can use and/or display the prevailing hourly wage rate and fringe benefits which are fetched from the system 100. No contractors are allowed to pay below this selected rate, they can pay more, but not less. Therefore, the system 100 provides for increased regulatory compliance by automatically determining wages based on real-time worker presence and automatic wage rate determination.

For unions, the determination of the wage can involve further steps and/or complications. For example, the system 100 and/or a user first identify the union the worker belongs to, then the system 100 determines (e.g., using a program run by the server 106) which wage rates are applicable for the worker and one is selected or pre-populated. After identifying which union then the system 100 must identify which county the system should fetch the workers rate from (in some cases it can be auto-determined, for example using location data from the gateway 102 corresponding to the worker device 104) then the system displays a list of applicable wages and a selection is made (manually or automatically) for the system to fetch the correct hourly wage and fringe benefits. Furthermore, in some instance a union may have different types of rates for the same worker, so selecting the type of rate is also applicable here. One benefit is that the system 100 collects, determines, and/or prompts a user for information that assists in driving or directing the user to the correct hourly wage rate and fringe benefits for the worker. This increases regulatory and contractual compliance.

By allowing the wages to be determined from the repository that has been qualified by the providing party—for example, the unions, city and local governments, federal government and private agencies—the workforce on a project is more likely to get paid the correct wages and fringe benefits (in comparison to manual determinations). In other words, the wages database 126 is populated by or with data from authoritative sources for the data. The relevant databases are built by aggregating relevant information and inputting this information into the database with the relevant associations such that the management server can make use of the information as described herein.

One skilled in the art would appreciate the structure of the database and how wages can be determined for prevailing wages, union wages, private wages, davis-bacon and others.

As a result of this data collection methods and processes, the contractors, government agencies and private providers are able to view and produce legislative minimum wage requirements. One skilled in the art will appreciate that those individuals responsible for verifying and validating that the correct wages and fringe benefits paid out have been pre-verified; therefore, reducing or eliminating any wage theft.

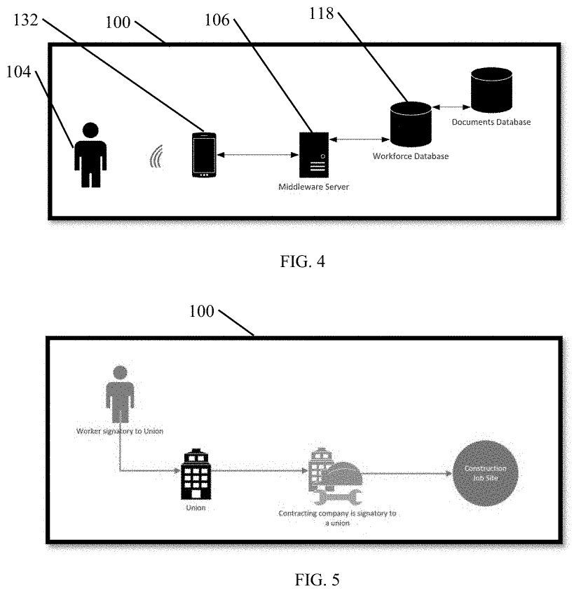

Furthermore, the systems and methods disclosed herein also provide the ability to validate a worker's identity/authenticity using, for example, a companion application running on a smartphone or other device 132 (e.g., an application running on a smartphone) and as depicted in FIG. 4. The device 132 is separate and distinct from the worker-worn device 104 and/or the gateway 102. The device 132 can, in some embodiments, replace the gateways(s) 102. In other embodiments, the device 132 supplements the gateway(s) 102. The device 132 and companion app allow for the identity of a worker to be confirmed manually by querying the worker's worker-worn device 104 (e.g., using Bluetooth, NFC, a QR reader, or the like). In response to a query, the device 132 can communicate with the server 106 for accessing information recorded and stored by the management server 106. This stored information can, in some embodiments, be provided to the server 106 through a worker portal accessible through the internet and interfaced with by a worker using a worker device (e.g., a smartphone, computer, tablet, or the like. The data input into the workforce database can be input using these devices, a contractor device 116, provided by other organizations (e.g., a union), aggregated from public sources, or otherwise input to the relevant database(s). By querying (e.g., with a gateway 102 or handheld device 114) the signaling device 104 worn by a person (e.g., the worker-worn device 104) or a manual input of the workers identification number and as demonstrated in FIG. 4, this information is transmitted to the Workforce Repository (e.g., workforce database 118 of the management server 106) through an API or other communications protocol or system in the event that the data is stored on the worker's device 104. In reading a worker's ID, the system 100 then searches the workforce database 118 (e.g., using the server 106) for a match of the signaling device's ID (e.g., the worker-worn device 104) or the manual input ID, and the system returns the following parameters: Workers full name, workers address, workers ethnicity, workers union # (if applicable), ethnicity, date of birth, certifications, documents, licenses, health related information, and or other information. Some or all of this information can be stored in a documents database accessible by the server 106 (e.g., licensure documents, identity documents, etc.). Additional parameters per worker can be retrieved. Only a partial list of parameters returned are explained here. One skilled in the art will appreciate the real-time data response to validate a worker. Furthermore, having access to this data in real-time in the situation of an emergency response can be key to a one's life.

Currently, each job-site worker carries with them a notepad, phone or paper in which they note what time they got to the job-site, what time they left, the total time worked, the type of work performed and their classification for that day. With the mobile function provided by communication between the management server 106 and a worker's device 104, the worker can check daily what time he arrived, what time he left and alter his classification or trade to determine how much he earned that day as determined based on the worker-worn device 104, gateways 102, and management server 106. If there are any discrepancies they can be alerted to the union or contractor to which he is signatory to or belongs to.

Furthermore, currently unions are oblivious as to what workers of the union are working where and for how long each day. As depicted by FIG. 1 and previously explained, the system 100 is able to autonomously determine the workers on-site duration and to which project they are assigned. This information is available to the union to which the worker is a signatory and is available in real-time (e.g., using a contractor device 116 or similar device). In reference to FIG. 5, a worker is signatory to a union and then the contracting companies are signatory to the union. The contracting companies are the ones who have the contract to perform work at the jobsite. For the purpose of explanation, assume you have Worker A, who is a carpenter. Worker A is a signatory to the local carpenters union. The contracting company has work to be performed. The contracting company will reach out to their local carpenters union to get the workforce. Each time the workers are on the job-site, the union does not know when and for how long their workforce is performing work each day. If there are any hours not reported to the union by the contracting company for Worker A then the union does not know there are missing hours for Worker A unless Worker A informs the union he is a signatory to. With the signaling devices (e.g., worker-worn devices 104) capability, the union has access to the real-time data as to where the members of their union are working and for how long each day (e.g., by querying the server 106 which stores information from received from the worker worn devices 104). This is important because fringe benefits many times are paid into the union, program, plans or funds per hour each worker works. Consequently, the union is insufficiently compensated for benefits owed by the contractor if the union is unaware of the number of hours worked by its members. The system 100 described herein provides that information to the union allowing for accurate accounting of what is owed.

Having the ability of real-time data provides the system with the capability of the following: real-time statistics of the project; such as, but not limited to: project goals, minority participation, classification ratios, gender participation, real-time project burn rate and more. Furthermore, traditional systems cannot analyze and predict upcoming billable hours because they are limited by the lack of real-time data. In contrast the system described herein has additional benefits in that it can predict in real-time the estimated burn hours by week for unsubmitted payrolls.

Also, no existing system can predict the estimated hours that will be billed unless those hours are already available in the system. Because the system as described herein collects data in real-time and stores it in the relevant database, the system 100 continuously knows how many hours a laborer has worked without completing the payroll. The system can then run a report that identifies week-by-week (or by other time period) how many hours are expected to be billed without needing a completed payroll cycle for data. This allows general contractors to have the insight, workforce budget-wise, to determine the burn rate and identify if the project is about to go over without waiting for a complete payroll cycle.

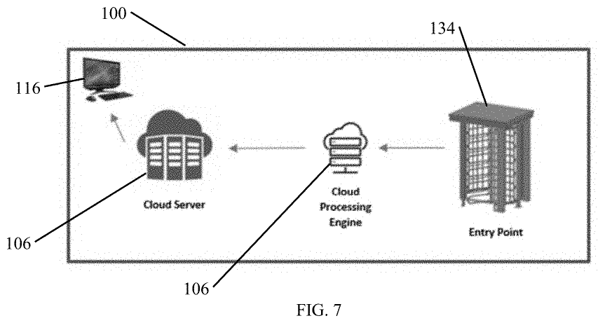

Additionally, the system 100 can include (alternatively or in addition to the worker worn devices 104 and gateways 102) turnstiles 134 or other access control devices as depicted in FIG. 7. Unlike existing access control devices, the turnstiles 134 can provide a source of data to server 106 (e.g., being a cloud server and/or cloud processing engine). The turnstiles 134 can for example require a worker present a worker-worn device 104, other worker device (e.g., a smartphone with an application running thereon), ID card, or other access pass/key including identifying information. Upon receipt of the identifying information, the turnstile communicates that data to the server 106 for use as previously described herein. The server 106 and the turnstile 134 can also provide access control by, for example, querying the workforce database 118 and/or the projects database 122 to provide access only to workers who are assigned to a particular jobsite. This is in contrast to existing access control devices which simply allow privileges/access to a job-site. Suh devices do not assist in providing workforce related information and collection of parameters, such as, but not limited to, worker name, badge number and event timestamp. This information once extracted and processed can be used as input to certified payroll.

Generally, the following is provided by the systems and methods described herein:
A system that collects laborer details in real-time via a signaling device and transmits it through a gateway 102 to a centralized server.
The details transmitted include but not limited to; singular or plurality of worker identification number(s), singular or plurality of timestamps of a worker, gateway 102 ID, antenna port, RSSI (received signal strength indicator) values, TID, user memory data, and heartbeat. The number of parameters through the gateway 102 can vary depending on the project where the data is collected.
A signaling device must be present that transmits its data through radio waves to the gateway 102.
The signaling device can be of any type; such as: Radio Frequency Identification (RFID) (active/passive), Quick Response (QR) Code, Barcode, Bluetooth, GPS, LoRa, NFC and finger-printer reader.
The gateway 102 must have a method to communicate its data to the cloud to a centralized server as depicted in FIG. 1.
The worker's related information is mapped to an assigned singular or plurality job-site of the worker.
The system autonomously determines the workers duration worked for a singular or plurality of job-sites based on the events received from the gateway 102 from one of the many types of signaling devices.
A system that maintains a wage repository as shown in FIG. 2. The repository contains the wages and fringe benefits for prevailing wages, union wages, Davis-bacon and private jobs.
The wages and fringe benefits are categorized further by jurisdiction. One type of jurisdiction can be of county type.
The ability to determine the workers wage type for a given project. The wage type can be of type, but not limited to: prevailing wages, union wages, David-bacon, private wages or a combination of 1 or more wages.
To determine the wage of a worker based on a series of parameters: project jurisdiction, project wage type, union the worker may be signatory to, worker classification and worker labor category. In some instances, more or less parameters may be used to determine a worker's wage and fringe benefits. Wages can be for straight time, over-time, double-time and any additional premiums.
Validating the authenticity of a worker by the signaling device or by manual input. The system identifies at minimum Workers full name, workers address, workers ethnicity, workers union #, ethnicity, date of birth, certifications, documents, licenses and health related information. Additional parameters per worker can be retrieved.
Timestamp a worker for a job-site by the signaling device or by manual input.
Identify the current workers on-site in real-time.
Auto-populate and auto-determine a worker's duration on a job-site for a given day.
A system that identifies in real-time the number of workers on-site by trade in real-time.
A system that identifies in real-time the number of workers on-site by contractor.
A system that identifies in real-time the number of past due payrolls by sub-contractor.
A system that identifies in real-time if a worker is in non-compliance.
The worker can validate their own hourly wage rate and fringe benefits and alerting any discrepancies.
The union is/are able to validate where the members of their union are on a daily basis, how many hours their members worked each day by project.
A system that does not allow any contractor to pay the workers an hourly wage rate and/or fringe benefits lower than that defined by the prevailing wages, union wages, Davis-bacon and private jobs wage rates.
The ability to autonomously collect and define payroll related information.
A system and method for compliance specialists and like to review the submitted payrolls of workers by the contracting companies.
The compliance specialist can approve or deny the payrolls.
If the payroll is to be denied then providing the denial reason for visibility by the contractor.
The system allows for the calculation of wage modifiers based on stored and received data such as, for example, straight time, over-time, double-time and any additional premiums based on the timestamps received from worker-worn devices.

Referring now to FIG. 6, the components of portions of the system are shown according to one embodiment. These components are used to perform the functions described herein and can be or include any of the sub-components, features, or functions as further described herein.

Generally, the functions, systems, processes, and the like described herein are implemented using software and database structures and operations of the type generally known in the art running on computing equipment of the type generally known in the art modified for the specific purposes and in the specific manners described herein. Databases of the type described herein can, for example, refer to either a body of data, a relational database management system (RDBMS), or to both. A database can, for example, include any collection of data including hierarchical databases, relational databases, flat file databases, object-relational databases, object-oriented databases, and any other structured collection of records or data that is stored in a computer system. Examples of RDBMS's include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

With respect to the databases described herein, several database related operations are described such as querying databases, comparing entries between databases, adding entries to databases for established values, adding information to an existing database of a type not already recorded in the database, creating new databases, reading from databases, and the like. To carry out these functions any suitable database operators, instructions, requests, functions, programs, code, or the like known to one skilled in the art can be used. For example, databases can be operated using structed query language (SQL) and operations can be carried out using clauses (e.g., constituent components of statements and queries), expressions (e.g., commands to produce either scalar values, or tables consisting of columns and rows of data), predicates (e.g., that specify conditions that can be evaluated to SQL three-valued logic true/false/unknown or Boolean truth values and are used to limit the effects of statements and queries, or to change program flow), queries (e.g., that retrieve that data based on specific criteria), statements (e.g., that have a persistent effect on schemata and data, or can control transactions, program flow, connections, sessions, or diagnostics), or the like. In should be understood that regardless of the particular implementation of a database and the corresponding programming language, data can be written to, read from, manipulated, compared, or otherwise processed using known data processing techniques and associated known programming techniques.

As described herein, components of the system and/or other components communicate with one another through instructions, requests, or the like. It should be understood that instructions, requests, or the like as described herein are digital messages, communications, program instructions, or the like that communicate information using, for example, a digital message having a compatible format. The message can be formatted according to an application programming interface (API), standard, or the like. The instructions, requests, or the like are formatted such that they are processed by the receiving entity. Such communication can be carried out using communications devices of each respective component. Communications devices of the type described herein include physical components (e.g., antenna's, processor, circuitry, etc.) and software or other instructions (e.g., firmware, instructions, communication standards, etc.). The communication device can be or include a WiFi module, cellular communication module, modem, Bluetooth module, NFC (near field communication) module, XBee module, and/or the like. The communication device can use any suitable corresponding communications standard such as an 802.11 standard, 4G or 5G cellular communications standard, Bluetooth 4.0 or 5.0, ECMA-340 NFC standard, XBee standard, TCP/IP, and/or the like.

The communication device can include components for cellular communication of voice, data, short message service, and/or Internet communication. Cellular communication can be achieved using system on a chip devices such as a processor adapted for cellular communication and coupled antennas. For example, cellular communication can be achieved using Qualcomm® or Apple® chips and antennas adapted for 4G, 4G LTE, 5G or other similar suitable communication standards. Communication can also be achieved using components for other suitable wireless communication such as processors and antennas for implementing a WiFi communication protocol and standard (e.g., 802.11a, 802.11n, or like standard), a Bluetooth communication protocol and standard (e.g., Bluetooth 5.0, or like standard). These standards can be used to communicate with an additional device allowing for pass through internet communications. In other words, the user device 102 can communicate with a further device using Bluetooth and the further device provides a bi-directional internet connection using additional communication equipment (e.g., a cellular communication device).

Processor of the type described herein can, for example, include any programmable system including systems using micro-controllers, reduced instruction set circuits (RISC), application specific integrated circuits (ASICs), logic circuits, and any other circuit or processor capable of executing the functions described herein.

The functions and systems described herein are implemented using, in part, software, firmware, programs, functions, or the like as described herein. These data processing systems and techniques can, for example, include any computer program stored in memory for execution by a processor, including RAM memory, ROM memory, EPROM memory, EEPROM memory, and non-volatile RAM (NV RAM) memory.

In some embodiments, a computer program is provided which performs some or all of the functions described herein with respect to individual components of the system, and the program can be embodied on a computer readable medium. In some embodiments, portions of the system and portions of the associated functions are executed on a single computer system, without requiring a connection to a sever computer. In some embodiments, all or portions of the systems and/or components described herein are being run in a Windows® environment (Windows is a registered trademark of Microsoft Corporation, Redmond, Wash.). In yet another embodiment, all or portions of the systems and/or components described herein are run on a mainframe environment and a UNIX® server environment (UNIX is a registered trademark of X/Open Company Limited located in Reading, Berkshire, United Kingdom). Applications of the type described herein should be understood to be flexible and designed to run in various different environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. The descriptions provided herein illustrate at least one example of carrying out the described functions. In addition, components of each system and each process can be practiced independent and separate from other components and processes described herein. Each component and process can also be used in combination with other assembly packages and processes.

Changes can be made in the above constructions without departing from the scope of the disclosure. It is intended that all matter contained in the above description or shown in the accompanying drawings shall be interpreted as illustrative and not in a limiting sense.

We claim:

1. A system comprising:
a worker-worn device adapted and configured to transmit an identification signal when queried;
a gateway adapted and configured to query worker-worn devices automatically when worker-worn devices are within interrogation range of the gateway and receive in response to the integration the identification signal, the identification signal including an identification corresponding to a worker to whom the worker-worn device is assigned, the gateway further adapted and configured to transmit, upon receiving the identification signal, the identification corresponding to a worker, a timestamp, and a gateway identification to a management server; and
a management server adapted and configured to receive from the gateway the identification corresponding to a worker, the timestamp, and the gateway identification, the management server adapted and configured to query a database using the gateway identification to determine the location of the worker-worn device, query a database using the location of the worker-worn device and the identification corresponding to a worker to identify the worker and a corresponding wage rate specific to the worker and the location, and determine a wage using the wage rate and the timestamp.

2. A system in accordance with claim 1, further comprising a plurality of gateways positioned in different locations, and wherein the management server is adapted and configured to determine the location of a worker based on signals received from one or more of the plurality of gateways.

3. A system in accordance with claim 1, further comprising a handheld contractor device adapted and configured to interrogate the worker-worn device and receive the identification corresponding to a worker, the handheld contractor device further adapted and configured to query the management server using the identification and receive corresponding biographic information stored by the management server.

4. A system in accordance with claim 3 wherein the biographic information includes one or more of full name, address, ethnicity, union number, ethnicity, date of birth, certifications, documents, licenses, or health related information

5. A system in accordance with claim 1, wherein the database includes prevailing wages, union wages, davis-bacon and private jobs wage rates identified by job location.

6. A system in accordance with claim 1 wherein the management server is adapted configured to determine the wage further using one or more of project jurisdiction, project wage type, union the worker may be signatory to, worker classification, or worker labor category.

7. A system in accordance with claim 1 wherein the management server is further adapted and configured to track certifications or licensures for workers and determine based on information received from the gateway if a worker is not in compliance with certification or licensure requirements and if such a determination is made transmit a corresponding alert.

8. A system in accordance with claim 1 wherein the identification signal includes one or more of at least one timestamp, at least one gateway identification, an antenna port value, an RSSI value, a TID value, worker-worn device memory data, GPS location data, or heartrate values.

9. A system in accordance with claim 1 wherein the gateway and the worker-worn device are adapted and configured such that the gateway can query the worker-worn device using one or more of radio frequency identification scanning, quick reference code scanning, barcode scanning, Bluetooth communication, LoRa communication, or near field communication.

10. A system in accordance with claim 3 wherein the handheld contractor device includes a finger print reader and wherein the handheld contractor device is adapted and configured to scan a fingerprint and query the management server for records associated with the scanned fingerprint.

11. A system in accordance with claim 1 wherein the management server is further adapted and configured to determine the wage using the location wherein the wage rate specific to the worker is stored for a plurality of locations.

12. A system in accordance with claim 1 wherein the wage includes fringe benefits and wherein the wage is determined based on stored wage rates including fringe benefits for prevailing wages, union wages, Davis-Bacon and private job rates.

13. A system in accordance with claim 12 wherein the stored wage rates including fringe benefits are stored based on jurisdiction including county level jurisdictions.

14. A system in accordance with claim 1 wherein the wage includes modifiers determined based on the identification signal including one or more of straight time, over-time, double-time, or a premium.

15. A system in accordance with claim 1 wherein the management server is adapted and configured to allow from the manual input of a timestamp.

16. A system in accordance with claim 1 wherein the management server is adapted and configured to automatically determine a worker's daily duration on a jobsite by taking the difference between the first and last timestamp received during a day from the gateway for a particular worker.

17. A system in accordance with claim 1 wherein the management server is adapted and configured to output in response to a query one or more of a list of all workers currently on a jobsite, a number of all workers currently on a jobsite, a number of all workers or a particular trade currently on a jobsite, a number of workers working for a particular contractor currently on a jobsite, a number of workers working for a particular subcontractor currently on a jobsite, a report that a particular worker is not in compliance with one or more requirements, a forecast of future payroll, or a record of total hours worked by all workers working for a particular contractor.

18. A system in accordance with claim 1 wherein the management server is adapted and configured to one or more of (A) report the determined wage to a worker and allow for the worker to validate or dispute the determined wage or (B) prevent the finalization of a payroll in which a contractor would pay a worker an hourly rate or fringe benefits lower that that defined by an associated one or more of prevailing wage rate, union wage rate, Davis-Bacon wage rate, or private job wage rate.

19. A system in accordance with claim 1 wherein the management server is adapted and configured to one or more of communicate to a union the location of union member workers based on received identification signals and corresponding locations of receiving gateways, communicate to a union the total number of hours worked per day by each union member worker associated with a particular project, communicate to a union a total amount of workforce hours spent on a particular job and corresponding fringe benefits calculation, communicate to a compliance specialist payrolls of workers per contractor, communicate to a compliance specialist an option to approve or deny a payroll of workers per contractor, or receive from a compliance specials a denial of a payroll submitted for approval including a denial reason for review by a contractor.

20. A system in accordance with claim 1 further including a turnstile adapted and configured to prevent entry to a jobsite absent the reception of an identification corresponding to a worker, the turnstile further adapted and configured to, upon reception of an identification corresponding to a worker, transmit to the management server an identification signal including the identification corresponding to the worker, a timestamp, and a turnstile identification.
